(19) United States
(12) Patent Application Publication
(10) Pub. No.: US 2014/0306393 A1
(43) Pub. Date: Oct. 16, 2014

(54) CONTAINER TREATMENT MACHINE

(71) Applicant: KRONES AG, Neutraubling (DE)

(72) Inventor: Dieter Hafner, Regensburg (DE)

(73) Assignee: KRONES AG, Neutraubling (DE)

(21) Appl. No.: 14/180,050

(22) Filed: Feb. 13, 2014

(30) Foreign Application Priority Data
Apr. 15, 2013 (DE) 10 2013 206 682.1

(51) Int. Cl. B23Q 1/25

(52) U.S. Cl. CPC B23Q 1/25
USPC 269/57

(57) ABSTRACT

A treatment machine for containers, in particular bottles, comprising a rotatable container table at least one lift guard cover formed laterally around the container table and at least one lateral machine cover secured to a lower frame below the lift guard cover. The machine cover is displaceable in a vertical direction on the lower frame. An area below the treatment machine is thus accessible for the purpose of cleaning without the necessity of demounting the machine cover.

### CROSS-REFERENCE TO RELATED APPLICATION

The present application claims priority to German Application No. 10 2013 206 682.1, filed Apr. 15, 2013. The priority application, DE 10 2013 206 682.1, is incorporated herein by reference.

### FIELD OF THE DISCLOSURE

The disclosure relates to a treatment machine for containers, in particular bottles.

### BACKGROUND

Rotary-type container treatment machines, such as labeling machines, need lateral lift guard covers in the area of the container table and machine covers on the lower frame disposed below the container table in view of the normally fast rotating machine components and for the purpose of complying with the prevalent safety regulations. The machine covers are normally fixedly screw-fastened to the lower frame and secured, by means of safety contacts or the like, against inadmissible removal during operation of the machine.

Between the container table and the machine cover, small parts, such as closure caps, shards or labels, may drop during operation of the machine, during conversions of production or the like. For cleaning the floor extending therebelow, it is then normally necessary to unscrew and remove the respective segments of the machine cover. This entails substantial effort for demounting/mounting the cover components. In addition, these cover components have to be protected separately by safety contacts against inadmissible demounting during operation of the machine.

Therefore, it would be desirable to simplify cleaning and/or reduce the amount and cost of the switches and circuits required for protecting the machine cover.

### SUMMARY

The treatment machine comprises a rotatable container table, at least one lift guard cover formed laterally around the container table and at least one lateral machine cover secured to a lower frame below the lift guard cover. According to the present disclosure the machine cover is displaceable in a vertical direction on the lower frame. An area below the treatment machine can be made easily accessible by pushing up the machine cover. In particular, demounting of the machine cover for the purpose of cleaning or the like in a lower area of the treatment machine will then not be necessary.

Preferably, the lift guard cover is configured as an upper mechanical stop for the machine cover. This means that the machine cover cannot be pushed upwards against the resistance of the lift guard cover. In other words, it is impossible to push the machine cover upwards in an inadmissible manner in the lowered condition of the lift guard cover. The machine cover can thus easily be protected against displacement when the treatment machine is in operation.

Preferably, an upper end face of the machine cover overlaps with a lower end face of the lift guard cover, when seen from above. The mechanical stop can here be realized particularly easily, especially without any additional mounted parts striking against one another.

Preferably, the lift guard cover and the machine cover are configured in the form of circular arcs or circular ring segments, when seen from above. Such segmented covers can be arranged at different positions along the machine circumference in a flexible manner. For the lift guard cover, e.g. a holding frame will then be provided, which, when seen from above, is also configured as a circular arc. Preferably, a plurality of lift guard cover segments can be secured in position at freely selectable angular positions of the treatment machine. The treatment machine in its entirety can thus be adapted to various dock-on treatment units in many ways.

Preferably, the machine cover is, in the circumferential direction, composed of at least two cover segments, which are separately displaceable in a vertical direction. The individual cover segments can be handled and/or exchanged comparatively easily.

Preferably, the machine cover is configured such that, when occupying a lower operating position, it does not extend beyond a predetermined safety distance from the ground on which the machine stands, e.g. from the floor. This safety distance is e.g. a distance of not more than 10 cm, in particular not more than 5 cm. The safety distance prevents e.g. operating staff from passing their hands below the machine cover and touching rotating machine components.

Preferably, the machine cover can be pushed upwards from a lower operating position without using any tool. This means especially that, in the raised condition of the lift guard cover, the machine cover can be pushed upwards from the lower operating position without the necessity of demounting or releasing locking elements, such as screws.

Preferably, the machine cover can be displaced up to and into an upper maintenance position. This is only possible when the lift guard cover associated therewith has adequately been raised. At the maintenance position of the machine cover, in particular the floor below the treatment machine is accessible for the purpose of cleaning.

Preferably, the treatment machine according to the present disclosure further comprises a locking unit for locking the machine cover at the upper maintenance position. The machine cover can thus be handled more easily without making use of any tool. In particular, inadvertent slipping down of the machine cover into the operating position will be avoided. The locking unit may comprise e.g. a clamping mechanism and/or fastening elements, such as ridges and grooves, resiliently engaging one another at the maintenance position.

A particularly advantageous embodiment of the treatment machine according to the present invention further comprises a protective switch such as a safety contact, which is operated when the lift guard cover is raised, so as to prevent operation of the machine. A reliable change between operation of the machine and a maintenance or cleaning measure can thus be guaranteed. If the lift guard cover acts as an upper mechanical stop for the machine cover, an additional protective switch for the machine cover can be dispensed with. In other words, it is then the protective switch of the lift guard cover that will prevent the machine cover from being raised during a motor-driven rotation of the container table. To this end, the protective switch will e.g. interrupt an electric safety circuit in the power supply of the associated motor.

Preferably, the lift guard cover is secured to an upper rail guide in a suspended and vertically displaceable fashion. The container table will thus be accessible also directly below the rail guide in the raised condition of the lift guard cover.

Preferably, the machine cover is vertically displaceable along vertical guide profiles. The corresponding guide elements on the machine cover can then be produced easily, e.g. by bending the machine cover or by attaching corresponding profiles. Such rail guides may be formed or secured in position on the lower frame at a plurality of mounting positions distributed in a suitable manner along the machine circumference.

Individual cover segments of the machine cover can then be pushed upwards separately so as to allow cleaning of individual areas of the machine. In addition, a plurality of flexibly exchangeable docking positions for treatment units can thus be formed along the machine circumference. For example, a single segment of the machine cover will then be demounted and a treatment unit will be docked instead of the respective segment.

Preferably, the lift guard cover can be raised by means of the rail guide to such an extent that the machine cover can be pulled off the vertical guide profiles in an upward direction. This allows a particularly easy exchange of individual cover segments of the machine cover.

Preferably, the treatment machine according to the present invention is configured as a labeling machine.

A preferred embodiment of the treatment machine according to the present disclosure is shown in the drawing, in which:

### BRIEF DESCRIPTION OF THE SEVERAL VIEW OF THE DRAWINGS

FIG. 1 shows a side view of the treatment machine according to the present disclosure;

FIG. 2 shows an oblique view of the treatment machine according to the present disclosure; and

FIG. 3 shows a fragmentary view with a machine cover according to the present disclosure.

### DETAILED DESCRIPTION OF THE PREFERRED EMBODIMENTS

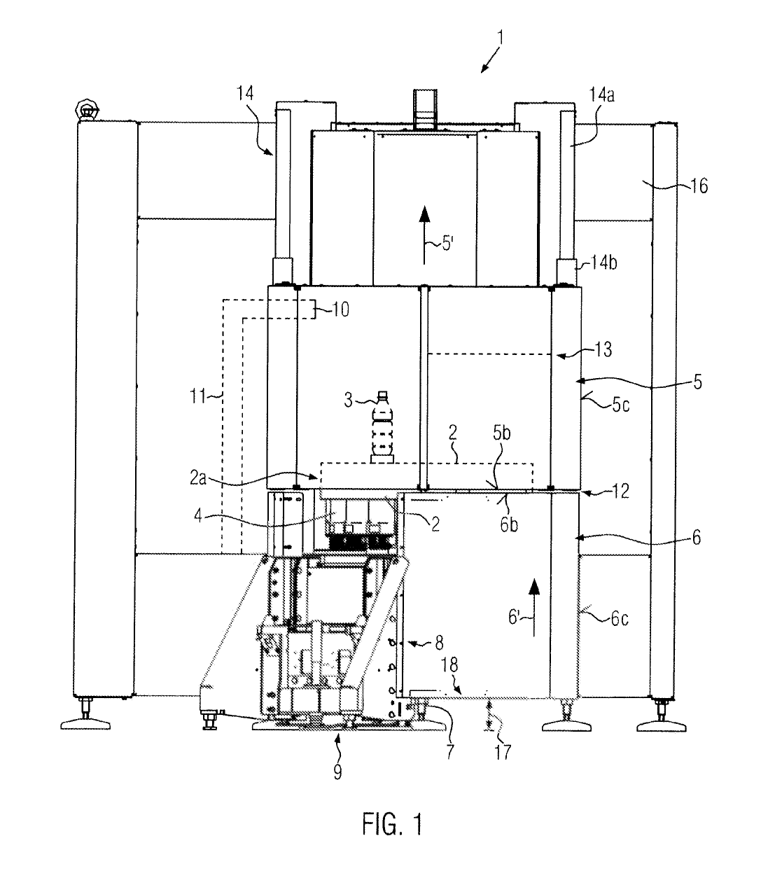

As can be seen in FIG. 1, a preferred embodiment of the treatment machine 1 according to the present disclosure comprises a rotatable container table 2 for treating, e.g. labeling, containers 3 such as beverage bottles or the like. Such container tables with circumferentially uniformly distributed treatment positions, at which the containers 3 are held upright e.g. on rotary plates, are known per se and will therefore not be explained in detail hereinbelow. In FIG. 1, a lower area of the container table 2 with motors 4 for rotary plates can be seen. The other areas of the container table 2 are covered by a lift guard cover 5 formed laterally around the container table 2 and a machine cover 6 formed therebelow. The latter prevents the operating staff from accessing the rotating motors 4 and other components rotating below the container table 2 when the machine is in operation, which accessing would be dangerous for them.

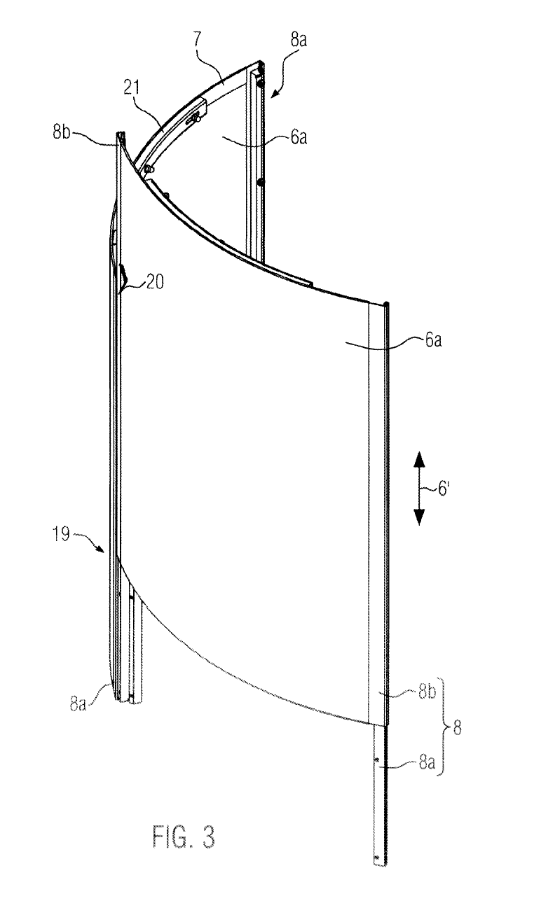

The machine cover 6 is secured to a stationary lower frame 7, which can especially be seen in FIG. 3, such that it is displaceable thereon in a vertical direction 6′. To this end, the lower frame 7 has formed thereon a lower rail guide 8 for the machine cover 6, said lower rail guide 8 comprising e.g. vertical guide profiles 8a. The machine cover 6 engages these vertical guide profiles 8a e.g. by means of corresponding profiles 8b. Preferably, a plurality of guide profiles 8a are formed along the circumference of the treatment machine 1 at suitable angular intervals of the machine, cf. FIG. 3.

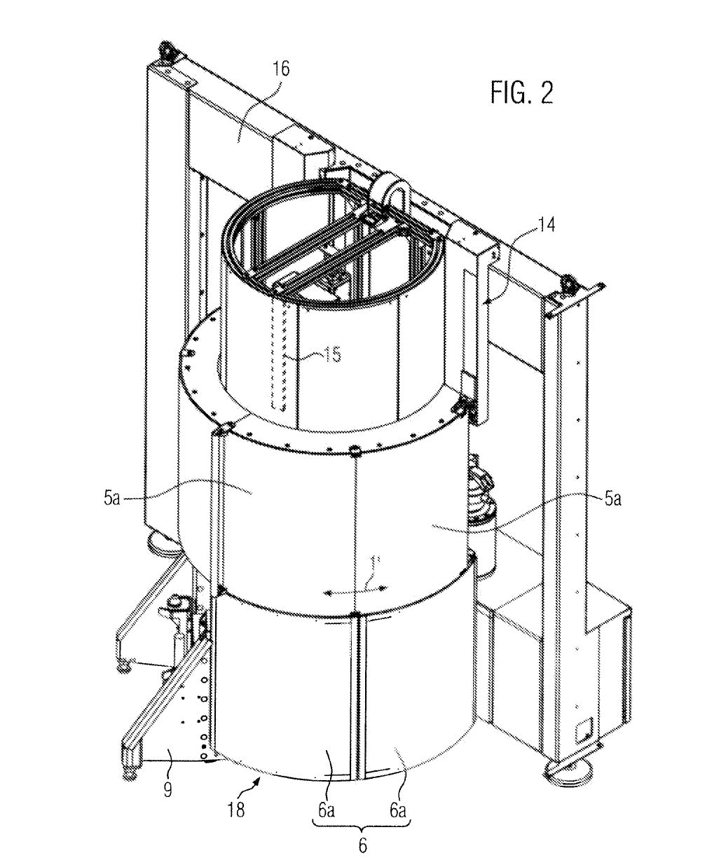

The machine cover 6 is preferably segmented along the circumference of the machine. FIG. 2 shows here exemplarily two cover segments 6a adjoining one another in a circumferential direction 1′ and disposed subsequent to a docking station 9 for docking a treatment unit (not shown), such as a labeling unit.

The lift guard cover 5 has preferably formed thereon at least one protective switch 10, which is schematically indicated in FIG. 1, e.g. in the form of an electric switching contact interrupting a schematically indicated electric safety circuit 11 as soon as the lift guard cover 5 is raised from a lower operating position 12, which is exemplarily shown in FIG. 1.

Raising the lift guard cover 5 up to and into an exemplarily indicated upper maintenance position 13 is possible due to the provision of a rail guide 14 with stationary guide rails 14a and movable slides 14b or the like. Alternatively, a variant comprising a rail guide 15 formed radially within the lift guard cover 5 and the machine cover 6 is imaginable, said variant being schematically indicated in FIG. 2. In both cases the lift guard cover 5 is displaceable in a vertical direction 6′ so as to make the container table 2 accessible from the side for the purpose of cleaning, retooling, maintenance or the like.

The rail guides 14, 15 are each mounted on an upper frame 16 such that they are secured against rotation relative thereto. The lift guard cover 5 is mounted on the rail guide 14, 15 in a suspended fashion such that, in the raised condition of the lift guard cover 5, the container table 2 is accessible from the side also below the rail guides 14, 15. This means in particular that stationary guide rails formed on the rail guides 14, 15 do not extend up to and into an area 2a laterally of or below the container table 2.

As can especially be seen from FIG. 2, the lift guard cover 5 and the machine cover 6 are, when seen from above, configured as cover segments 5a, 6a in the form of overlapping circular ring segments or circular arcs. According to a particularly advantageous embodiment, a lower end face 5b of the lift guard cover 5 and an upper end face 6b of the machine cover 6 overlap. Also a flush transition between the outer surfaces 5c, 6c of the lift guard cover 5 and of the machine cover 6 will be advantageous.

In view of the fact that the cross sections of the lift guard cover 5 and of the machine cover 6 overlap one another, when seen from above, the lift guard cover 5 acts as an upper mechanical stop for the machine cover 6. This means that the machine cover 6 cannot be pushed upwards against the resistance of the lowered lift guard cover 5. It is therefore not necessary to provide a separate protective switch and/or protective circuit for the machine cover 6. Nevertheless, separate protective switches for the machine cover 6 would be imaginable as a supplementary safety measure.

Although the protective switch 10 is not directly operated by the machine cover 6, but by means of the lift guard cover 5, operation of the machine can reliably be prevented as soon as a given maximum vertical distance 17 between the machine cover 6 and the floor area on which the treatment machine 1 stands is exceeded. The maximum distance 17 is specified e.g. in accordance with the respective safety regulations to be applied. Therefore, the least one protective switch 10 will suffice to prevent inadmissible lateral access to the container table 2 in the area of the lift guard cover 5 as well as inadmissible access to the driving components or the like rotating below the container table 2.

The circumferential segmenting of the lift guard cover 5 and of the machine cover 6 facilitates flexible docking of treatment units in various areas along the machine circumference. To this end, mounting positions for the guide rails 8a may be provided, said mounting positions being distributed along the circumference at suitable angular intervals. The lift guard cover 5 can, preferably in its entirety, be pushed upwards on the rail guide 14, 15. Nevertheless, openings for respective units (not shown) with covers or the like, may be formed in the lift guard cover 5 with the aid of the individual cover segments 5a, whereas the individual circumferential cover segments 6a of the machine cover 6 can preferably be raised separately. Due to the then comparatively low weight of the individual cover segments 6a, it will be easier to raise the machine cover 6 and/or to lock the raised machine cover 6 in position.

FIGS. 1 and 2 each show the machine cover 6 at a lowered operating position 18, whereas FIG. 3 exemplarily shows a cover segment 6a of the machine cover 6 at a raised maintenance position 19. This allows access to an area below the treatment machine 1 for the purpose of cleaning or the like.

For locking the machine cover 6 at an upper maintenance position 19, e.g. an only schematically indicated locking unit 20 in the form of a spring-loaded snap mechanism, a clamping mechanism or the like may be provided. At the lower operating position 18, locking of the machine cover 6 can, however, be dispensed with. The machine cover 6 can thus be raised more easily without using any tools.

The vertically displaceable machine cover 6 especially allows easy cleaning below the treatment machine 1 according to the present disclosure. The fact that the lift guard cover 5 and the machine cover 6 are round in shape, when seen from above, facilitates a flexible adaptation of the treatment machine 1 to different treatment situations and/or docking of various treatment units. Especially for labeling machines, which may have to be capable of processing different labels and/or containers, the segmented and modular structural design of the machine cover 6 allows a flexible adaptation to the respective production conditions with simultaneously improved access to areas below the treatment machine 1. In particular dropped labels, label components, bits of broken glass or the like can thus be removed rapidly and the operating efficiency of the system can be increased.

1. A treatment machine for containers, comprising:
a rotatable container table;
a lift guard cover formed laterally on the container table;
a lateral machine cover secured to a lower frame 0 below the lift guard cover,
the machine cover being displaceable in a vertical direction on the lower frame.

2. The treatment machine according to claim 1, wherein the lift guard cover is configured as an upper mechanical stop for the machine cover.

3. The treatment machine according to claim 1, wherein an upper end face of the machine cover overlaps with a lower end face of the lift guard cover, when seen from above.

4. The treatment machine according to claim 1, wherein the lift guard cover and the machine cover are configured in the form of circular arcs, when seen from above.

5. The treatment machine according to claim 1, wherein the machine cover, in the circumferential direction, comprises at least two cover segments, which are separately displaceable in a vertical direction.

6. The treatment machine according to claim 1, wherein, when occupying a lower operating position, the machine cover does not extend beyond a predetermined safety distance from a floor area on which the machine stands, said safety distance being a distance of not more than 10 cm.

7. The treatment machine according to claim 1, wherein the machine cover can be pushed upwards from a lower operating position without using any tool.

8. The treatment machine according to claim 1, wherein the machine cover can be displaced up to and into an upper maintenance position.

9. The treatment machine according to claim 8, further comprising a locking unit for locking the machine cover at the upper maintenance position.

10. The treatment machine according to claim 1, further comprising a protective switch, which is operated when the lift guard cover is raised, so as to prevent operation of the machine.

11. The treatment machine according to claim 1, wherein the lift guard cover is secured to an upper rail guide in a suspended and vertically displaceable fashion.

12. The treatment machine according to claim 1, wherein the machine cover is vertically displaceable along stationary guide profiles .

13. The treatment machine according to claim 11, wherein the lift guard cover can be raised by means of the rail guide to such an extent that the machine cover can be pulled off the vertical guide profiles in an upward direction.

14. The treatment machine according to claim 1, the treatment machine being configured as a labeling machine.
